(19) United States
(12) Patent Application Publication
(10) Pub. No.: US 2005/0150279 A1
(43) Pub. Date: Jul. 14, 2005

(54) Pressure-based fluid corrosion/erosion protection apparatus and associated methods

(76) Inventors: Bruce E. Taber, Bothell, WA (US); Ford S. Kimmel, Westlake Village, CA (US)

Correspondence Address: KONNEKER & SMITH P. C., 660 NORTH CENTRAL EXPRESSWAY, SUITE 230, PLANO, TX, 75074, US

(21) Appl. No.: 10/753,787

(22) Filed: Jan. 8, 2004

(51) Int. Cl. G01N 17/00; G01N 17/04; B65D 25/00

(52) U.S. Cl. 73/86; 220/694; 220/917

(57) ABSTRACT

The interior of a vessel containing pressurized fluid is protected against undesirable chemical corrosion and/or mechanical erosion caused by the fluid due, for example, to changes in the chemistry of the fluid, by an imperforate, chemically corrodable tube projecting into the interior of the vessel and having a closed inner end. A chemical corrosion through-opening in any portion of the tube permits pressurized fluid to enter and pressurize the tube interior, with fluid pressure within the tube being utilized to automatically generate a corrosion/erosion detection signal indicative of an undesirably high fluid chemical corrosivity level within the vessel.

### BACKGROUND OF THE INVENTION

The present invention generally relates to protecting fluid containing vessels from chemical corrosion and/or mechanical erosion by fluid disposed therein and, in illustrated embodiments thereof, more particularly provides specially designed pressure-based chemical corrosion/mechanical erosion monitoring and protection apparatus and associated methods for such vessels.

Fluid-containing vessels, such as tanks and the like, are often susceptible to internal corrosion and/or erosion damage, and corresponding premature failure when the chemical corrosivity level of the fluid which they contain increases. For example, water chemistry is known to attack boiler, water heater and chiller tank materials, with the result that the tanks, and associated fluid system materials, can prematurely deteriorate.

Various proposals have previously been made for monitoring corrosion of a sacrificial member disposed in fluid contained within a vessel and automatically generating a protective corrosion detection output signal. Generation of this corrosion detection signal permits suitable maintenance to be performed prior to premature corrosion damage to the vessel. A primary disadvantage of many of these previously proposed corrosion detection systems has been their structural and/or fabricational complexity which undesirably increases their overall costs.

A need thus exists for a simpler, less expensive technique for monitoring a vessel and protecting it from chemical corrosivity of fluid which it contains. It is to this need that the present invention is directed.

### SUMMARY OF THE INVENTION

In carrying out principles of the present invention, in accordance with representatively illustrated embodiments thereof, a vessel adapted to contain a quantity of pressurized fluid is provided with specially designed apparatus and associated methods which detect a predetermined, corrosivity level in the fluid (created, for example, by a change in its chemistry during operation of a system in which the vessel is incorporated) and responsively generates a corrosion/erosion detection signal.

In one representative embodiment thereof, the corrosion protection apparatus comprises a sacrificial member having a hollow interior bounded by a chemically corrodable outer wall disposed within the vessel, the outer wall being configured and constructed to corrode through to the interior of said sacrificial member in response to exposure of the outer wall to a predetermined combination of fluid exposure time and fluid chemical corrosivity correlated to a predetermined amount of chemical corrosion and/or mechanical erosion by the fluid of the interior of the vessel; and a monitoring system operative to receive fluid pressure from the interior of the sacrificial member and responsively generate an output signal indicative of an unacceptably high chemical corrosivity level of fluid within the vessel. The sacrificial member may be mounted within the vessel or may otherwise be communicated with its interior, such as by being mounted in a fluid conduit communicating with the interior of the vessel to be protected.

In a second representative embodiment thereof, the corrosion protection apparatus comprises at least one additional sacrificial member substantially identical to the first sacrificial member. The interiors of the sacrificial members are communicated, representatively by flexible conduits, to provide the corrosion/erosion protection apparatus with a desirable redundancy in corrosion detection.

Preferably, the hollow sacrificial members used in these illustrative embodiments, which provide the vessel with chemical corrosion protection as opposed to cathodic protection against electrical-based corrosion, are non-anode members, have hollow imperforate tubular configurations with closed inner ends disposed within the vessel, have interiors which are empty prior to receiving pressurized vessel fluid therein, with a chemical corrosion-created hole in any portion of the tube wall causing pressurized fluid within the vessel to enter and pressurize the interior of the tube.

The monitoring system may take a variety of alternate forms including, for example, a switch structure mechanically actuated by transmission thereto of vessel fluid pressure transmitted thereto via the interior of a chemically corroded sacrificial member and coupled to an electrical monitoring circuit operative to responsively output the corrosion detection signal, or a suitable mechanical device operative to receive a fluid pressure generated force and responsively output a mechanical corrosion/erosion detection signal.

### BRIEF DESCRIPTION OF THE DRAWINGS

FIG. 1 is a schematic cross-sectional view through a portion of a pressurized fluid-containing vessel having associated therewith specially designed pressure-based chemical corrosion/mechanical erosion protection apparatus embodying principles of the present invention;

FIG. 2 is a schematic representation of a mechanical version of a portion of the chemical corrosion/mechanical erosion protection apparatus; and

FIG. 3 is a schematic cross-sectional view through a portion of a pressurized fluid-containing vessel having associated therewith an alternate embodiment of the chemical corrosion/mechanical protection apparatus depicted in FIG. 1.

### DETAILED DESCRIPTION

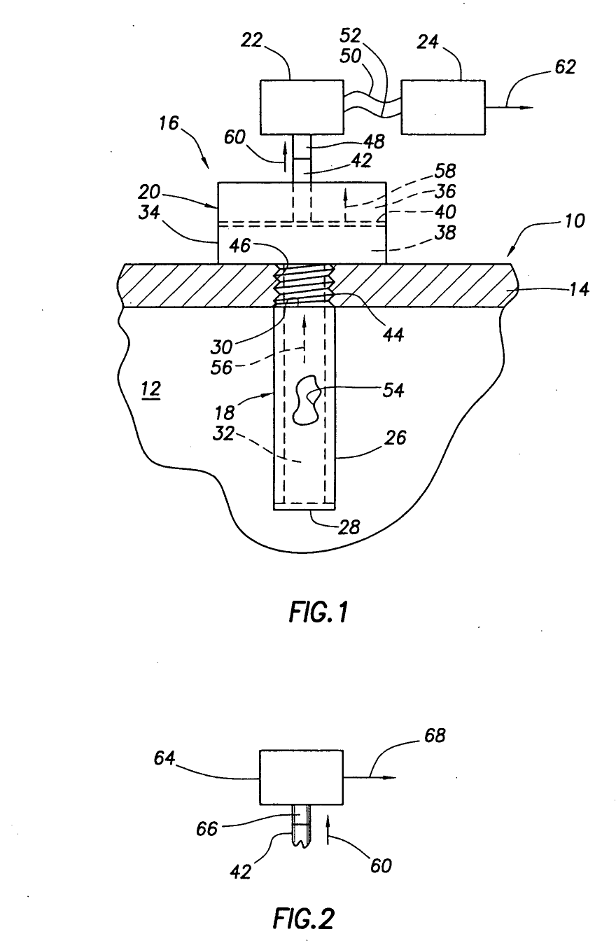

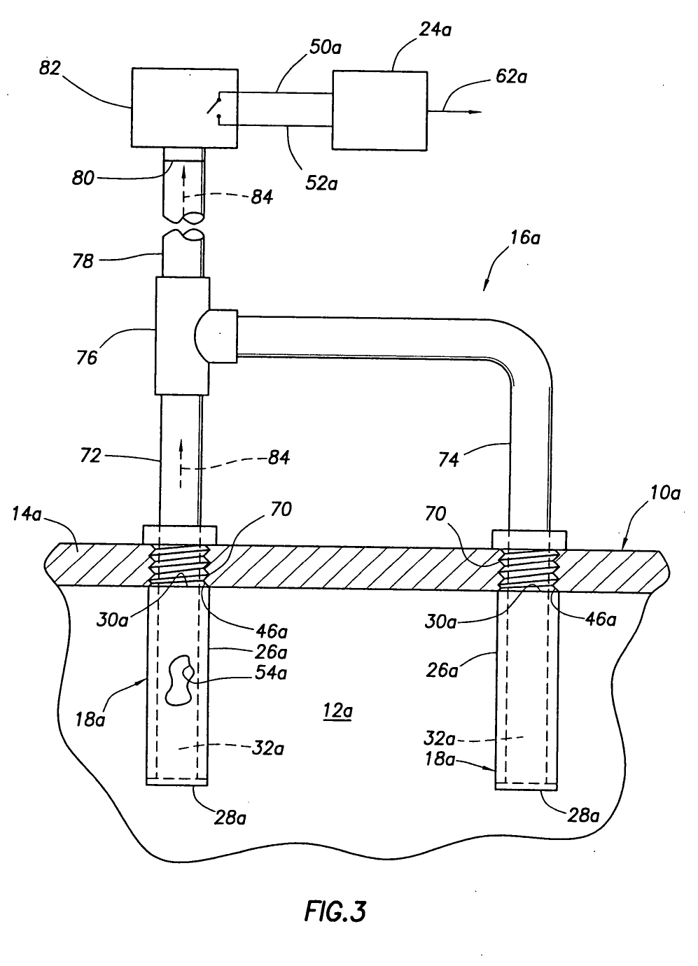

Schematically depicted in FIG. 1 is an illustrative vessel 10 adapted to hold a pressurized fluid 12 and having a chemically corrodable or mechanically erodable outer wall 14. The pressurized fluid 12 may be a liquid, such as water, or a gas, and the vessel 10 may representatively, but not by way of limitation, be a metal tank of the type used in water heaters, boilers, chillers or the like.

Operatively associated with the vessel 10, and embodying principles of the present invention, is specially designed protective apparatus 16 for protecting the vessel 10 against chemical corrosion and/or mechanical erosion of the interior surface of its outer wall 14 by the fluid 12 within the vessel 10 in the event that the chemical corrosivity of the fluid 12 becomes undesirably high. The protective apparatus 16, in the illustrative embodiment thereof shown in FIG. 1, includes a hollow sacrificial member 18 disposed within the interior of the vessel 10, a pressure diaphragm assembly 20, an electrical switch 22, and a suitable electrical monitoring circuit 24. While the sacrificial member 18 is representatively illustrated as being disposed within the vessel 10, it could be otherwise communicated with the vessel's interior such as being placed in a fluid conduit (not shown) communicated with the interior of the vessel 10. The sacrificial member 18 may thus be said to be “communicated with” the interior of the vessel in either of these two situations.

The hollow sacrificial member 18, which is shown projecting downwardly into the interior of the vessel 10, is representatively a tube formed from a suitable chemically corrodable material such as a selected metal, and has an initially imperforate side wall 26, a closed inner end 28, and an open upper end 30. When the tube 18 is initially positioned within the vessel 10, the interior 32 of the tube 18 is empty, and is isolated from the interior of the vessel 10 by the tube side and end walls 26,28 which enclose the tube interior 32 and are directly exposed to the fluid 12. While the hollow sacrificial member 18 representatively has a tubular configuration, it could alternatively have a variety of other imperforate, hollow, enclosing configurations if desired without departing from principles of the present invention.

Pressure diaphragm assembly 20 has a housing 34 internally divided into upper and lower chambers 36,38 by a flexible diaphragm member 40. A vertically movable actuating member 42 is engaged by the top side of the diaphragm member 40, and a hollow tubular connection section 44 projects downwardly from the bottom side of the housing 34. As indicated in FIG. 1, the connection section 44 is sealingly threaded into a corresponding opening 46 in the vessel wall 14 and is suitably secured to the open upper end 30 of the sacrificial tube 18 in a manner communicating the tube interior 32 with the lower chamber 38 of the diaphragm assembly housing 34.

The electrical switch 22 has a mechanical actuating portion 48 operatively engaged by the diaphragm assembly actuating member 42, and switch 22 is operatively coupled to the monitoring circuit 24 by the schematically depicted leads 50,52.

According to a feature of the present invention, the hollow, chemically corrodable sacrificial tube 18 is configured and constructed (for example, as to its material and wall thickness) to corrode through to its interior 32 (at, for example, the illustrative side wall corrosion hole 54) in response to exposure of its immersed outer wall section 26,28 to a predetermined combination of fluid exposure time and fluid chemical corrosivity within the vessel 10 correlated to a predetermined limited amount of chemical corrosion and/or mechanical erosion by the fluid of the interior of the outer vessel wall 14. Depending on the particular application, this predetermined, limited amount of chemical vessel corrosion and/or mechanical erosion may be very small, or may be substantial (but, of course, well short of vessel failure). By virtue of this design feature of the present invention, a corrosion through-opening will be created in the sacrificial tube 18 before an unacceptable level of chemical corrosion and/or mechanical erosion damage is caused to the interior of the vessel wall 14 by an increased chemical corrosivity level of the pressurized fluid 12.

It should be noted that the tube 18 is not designed as a sacrificial anode structure in that it functions to protect the vessel 10 against chemical corrosion and/or mechanical erosion as opposed to cathodically protecting the vessel 10 against electrically-created corrosion. The tube 18, in a preferred embodiment thereof, may thus be referred to generally as a hollow, chemically corrodable sacrificial non-anode structure.

When the inserted, initially imperforate tube 18 is subjected to the predetermined combination of fluid exposure time and fluid chemical corrosivity within the vessel 10, the tube 18 corrodes through (for example at the depicted side wall opening 54), at which time pressurized fluid 12 flows through the opening 54 into the empty tube interior 32 and flowing upwardly therethrough toward the lower diaphragm chamber 38 as indicated by the arrow 56 in FIG. 1. The resulting fluid pressurization of the lower diaphragm chamber 38 forces the diaphragm 40 upwardly, as indicated by the arrow 58. In turn, the forced upward movement of the diaphragm 40 upwardly moves the actuating members 42 and 48, as indicated by the arrow 60, to operate the electrical switch 22. In response to the operation of the switch 22, the monitoring circuit 24 automatically generates an appropriate corrosion/erosion detection signal 62 which may be utilized to notify maintenance personnel that the chemical corrosivity of the fluid 12 has reached an unacceptably high level so that appropriate corrective action can be taken.

It is important to note that the tube 12 functions both as a chemically corrodable trigger element in the overall protective apparatus 16 and a fluid pressure transport structure. Coupled with the quite simple and relatively inexpensive other portions of the protective apparatus 16, this advantageously provides the vessel 10 with chemical corrosion protection which is simple, inexpensive and reliable.

While the fluid chemical corrosion-created opening 54 shown in FIG. 1 is representatively positioned in the tube side wall 26 generally centrally along the tube length, a fluid chemical corrosion-created opening in any portion of the immersed tube wall 26,28 will completely fill and pressurize the tube interior 32 and responsively create the same automatically generated corrosion detection signal 62. Thus, the corrosion protection function of the tube 18 is independent of both the location of the wall corrosion opening formed therein and the vertical extent of the fluid chemical corrosion to which the tube is subjected.

Additionally, pressure-driven output components other than the representatively depicted electrical switch 22 and associated electrical circuit 24 could be alternatively utilized in the protective apparatus 16, if desired, without departing from principles of the present invention.

For example, as shown in FIG. 2, the electrical switch 22 and the electrical circuit 24 shown in FIG. 1 could be replaced with a suitable mechanical indicating device 64 having a force input portion 66 which, when forcibly engaged by the diaphragm assembly actuating member 42, responsively outputs a mechanical detection signal 68. As another alternative, as later described herein, the protective components 20,22 shown in FIG. 1 may be replaced with a pressure-to-electric switch operatively interposed between the open upper end 30 of the tube 18 and the monitoring circuit 24.

An alternate embodiment 16a of the previously described chemical corrosion/mechanical erosion protective apparatus 16 of FIG. 1 is schematically shown in FIG. 2. In order to facilitate ready comparison between the apparatus 16 and the apparatus 16a, components in the apparatus 16a similar to those in apparatus 16 have been given identical reference numerals to which the subscripts “a” have been added.

The protective apparatus 16a shown in FIG. 2 is operatively associated with a representative vessel 10a, having a spaced pair of openings 46a formed in its outer wall 14a, and includes two chemically corrodable sacrificial tubes 18a each substantially identical in construction and operation to the previously described tube 18. The open upper tube ends 30a are secured to hollow cylindrical connection structures 70 sealingly and threadingly received in the spaced apart vessel wall openings 46a. As shown, the interiors 32a of the tubes 18a are communicated with one another by means of flexible conduits or tubes 72,74. Conduit 72 is interconnected between the left tube 18a and a first leg of a tee fitting 76, and conduit 74 is interconnected between the right tube 18a and a second leg of the tee fitting 76. A flexible conduit 78 is interconnected between the third leg of the tee fitting 78 and the pressure inlet 80 of a conventional pressure-to-electric switch 82 coupled, in turn, to the monitoring circuit 24a by leads 50a,52a.

Via the flexible conduits 72, 74 and 76, the interiors 32a of both of the tubes 18a communicate with the pressure inlet 80 of the pressure-to-electric switch 82. Accordingly, when a chemical corrosion through-opening is created in any portion of either of the tubes 18a (for example, the corrosion opening 54a illustratively shown in the left tube 18a), pressurized fluid 12a enters such tube, completely fills and pressurizes its interior 32a, and flows through the flexible tubing (as indicated by the arrows 84 extending through conduits 72,78 from the perforated left tube 18a). This pressurizes the switch inlet 80 and actuates the switch 82 (either opening or closing it as the case may be) to thereby responsively cause the monitoring circuit 24a to output the corrosion/erosion detection signal 62a.

As previously mentioned, a fluid chemical corrosion opening formed in any portion of either of the two tubes 18a responsively creates the corrosion detection signal 62a. Thus, compared to the previously described protective apparatus 16, the protective apparatus 16a incorporates therein a desirable corrosion detection redundancy while at the same time providing a simple, inexpensive and reliable chemical corrosion protection for the vessel 10a.

The foregoing detailed description is to be clearly understood as being given by way of illustration and example only, the spirit and scope of the present invention being limited solely by the appended claims.

1. Apparatus for protecting a vessel against chemical corrosion and/or mechanical erosion thereof caused by a pressurized fluid disposed therein, said apparatus comprising:
a sacrificial member having a hollow, substantially empty interior bounded by a chemically corrodable imperforate outer wall exteriorly exposable to pressurized fluid within the vessel, said outer wall being configured and constructed to corrode through to the interior of said sacrificial member in response to exposure of said outer wall to a predetermined combination of fluid exposure time and fluid chemical corrosivity within the vessel correlated to a predetermined amount of chemical corrosion and/or mechanical erosion by the fluid of the interior of said vessel, a chemical corrosion-created hole in any portion of said imperforate outer wall causing pressurized fluid to enter and pressurize the empty interior of said sacrificial member; and
a monitoring system operative to receive fluid pressure from the interior of said sacrificial member and responsively generate an output signal indicative of an unacceptably high chemical corrosivity level of fluid within the vessel,
said monitoring system including a pressure diaphragm assembly having a housing interiorly divided into first and second chambers by a flexible diaphragm member, the first chamber communicating with the interior of said sacrificial member, and a movable actuating member extending through the interior of said second chamber and engaged by said diaphragm member, pressurized fluid entering the interior of said sacrificial member through the chemical corrosion-created hole pressurizing said first chamber in a manner moving said flexible diaphragm member to cause it to push said actuating member away from an initial position thereof.

2. The apparatus of claim 1 wherein:
said sacrificial member is a tube with a closed inner end, and an open outer end.

3. (canceled)

4. The apparatus of claim 1 wherein:
said monitoring system further includes an electrical switch having a body portion from which a depressible mechanical actuating portion outwardly projects, said mechanical actuating portion being engaged and depressible by said movable actuating member.

5. The apparatus of claim 4 wherein:
said monitoring system further includes an electrical circuit coupled to said switch and operable thereby to responsively generate a corrosion detection output signal.

6. The apparatus of claim 1 wherein:
said monitoring system further includes mechanical apparatus engaged and operative by said movable actuating member to responsively generate a mechanical corrosion detection output signal.

7-8. (canceled)

9. Apparatus for protecting a vessel against chemical corrosion and/or mechanical erosion thereof caused by a pressurized fluid disposed therein, said apparatus comprising:
a sacrificial member having a hollow, substantially empty interior bounded by a chemically corrodable imperforate outer wall exteriorly exposable to pressurized fluid within the vessel, said outer wall being configured and constructed to corrode through to the interior of said sacrificial member in response to exposure of said outer wall to a predetermined combination of fluid exposure time and fluid chemical corrosivity within the vessel correlated to a predetermined amount of chemical corrosion and/or mechanical erosion by the fluid of the interior of said vessel, a chemical corrosion-created hole in any portion of said imperforate outer wall causing pressurized fluid to enter and pressurize the empty interior of said sacrificial member; and
a monitoring system operative to receive fluid pressure from the interior of said sacrificial member and responsively generate an output signal indicative of an unacceptably high chemical corrosivity level of fluid within the vessel,
said sacrificial member being a first sacrificial member, and
said apparatus further comprising a second sacrificial member substantially identical to said first sacrificial member, the interiors of said first and second sacrificial members being communicated with one another,
each of said first and second sacrificial members being associateable with said vessel in a manner exposing them to pressurized fluid in its interior.

10. The apparatus of claim 9 wherein:
the interiors of said first and second sacrificial members are communicated with one another by tubing interconnected between said first and second sacrificial members.

11. The apparatus of claim 9 wherein:
said first and second sacrificial members have generally tubular configurations, with closed inner ends and open outer ends, and are threadable into spaced apart openings in the outer wall of the vessel.

12. (canceled)

13. Fluid containment apparatus comprising:
a vessel adapted to contain a pressurized fluid; and
corrosion/erosion protection apparatus for protecting said vessel from chemical corrosion and/or mechanical erosion by pressurized fluid disposed within said vessel, said corrosion/erosion protection apparatus including:
a sacrificial member having a hollow, substantially empty interior bounded by a chemically corrodable imperforate outer wall communicated with the interior of said vessel, said outer wall being configured and constructed to corrode through to the interior of said sacrificial member in response to exposure of said outer wall to a predetermined combination of fluid exposure time and fluid chemical corrosivity correlated to a predetermined amount of chemical corrosion and/or mechanical erosion by the fluid of the interior of said vessel, a chemical corrosion-created hole in any portion of said imperforate outer wall causing pressurized fluid to which said sacrificial member is exposed to enter and pressurize the interior of said sacrificial member; and
a monitoring system operative to receive fluid pressure from the interior of said sacrificial member and responsively generate an output signal indicative of an unacceptably high chemical corrosivity level of fluid within the vessel, said monitoring system including a pressure diaphragm assembly having a housing interiorly divided into first and second chambers by a flexible diaphragm member, the first chamber communicating with the interior of said sacrificial member, and a movable actuating member extending through the interior of said second chamber and engaged by said diaphragm member, pressurized fluid entering the interior of said sacrificial member through the chemical corrosion-created hole pressurizing said first chamber in a manner moving said flexible diaphragm member to cause it to push said actuating member away from an initial position thereof.

14. The fluid containment apparatus of claim 13 wherein:
said sacrificial member is a tube with a closed inner end, and an open outer end.

15. (canceled)

16. The fluid containment apparatus of claim 13 wherein:
said monitoring system further includes an electrical switch having a body portion from which a depressible mechanical actuating portion outwardly projects, said mechanical actuating portion being engaged and depressible by said movable actuating member.

17. The fluid containment apparatus of claim 16 wherein:
said monitoring system further includes an electrical circuit coupled to said switch and operable thereby to responsively generate a corrosion/erosion detection output signal.

18. The fluid containment apparatus of claim 13 wherein:
said monitoring system further includes mechanical apparatus engaged and operative by said movable actuating member to responsively generate a mechanical corrosion/erosion detection output signal.

19-20. (canceled)

21. Fluid containment apparatus comprising:
a vessel adapted to contain a pressurized fluid; and
corrosion/erosion protection apparatus for protecting said vessel from chemical corrosion and/or mechanical erosion by pressurized fluid disposed within said vessel, said corrosion/erosion protection apparatus including:
a sacrificial member having a hollow, substantially empty interior bounded by a chemically corrodable imperforate outer wall communicated with the interior of said vessel, said outer wall being configured and constructed to corrode through to the interior of said sacrificial member in response to exposure of said outer wall to a predetermined combination of fluid exposure time and fluid chemical corrosivity correlated to a predetermined amount of chemical corrosion and/or mechanical erosion by the fluid of the interior of said vessel, a chemical corrosion-created hole in any portion of said imperforate outer wall causing pressurized fluid to which said sacrificial member is exposed to enter and pressurize the interior of said sacrificial member; and
a monitoring system operative to receive fluid pressure from the interior of said sacrificial member and responsively generate an output signal indicative of an unacceptably high chemical corrosivity level of fluid within the vessel,
said sacrificial member being a first sacrificial member, and
said apparatus further comprising a second sacrificial member substantially identical to said first sacrificial member, the imperforate outer wall of said second sacrificial member being communicated with the interior of said vessel and being in a spaced relationship with the imperforate outer wall of said first sacrificial member, and the interiors of said first and second sacrificial members being communicated with one another.

22. The fluid containment apparatus of claim 21 wherein:
the interiors of said first and second sacrificial members are communicated with one another by tubing interconnected between said first and second sacrificial members.

23. The fluid containment apparatus of claim 21 wherein:
said first and second sacrificial members have generally tubular configurations, with closed inner ends and open outer ends, and are sealingly received in spaced apart openings in the outer wall of the vessel.

24-37. (canceled)

38. Fluid containment apparatus comprising:
a vessel adapted to contain a pressurized fluid and having a wall opening therein; and
corrosion/erosion protection apparatus for protecting said vessel from chemical corrosion and/or mechanical erosion by pressurized fluid disposed within said vessel, said corrosion/erosion protection apparatus including:
a pressure diaphragm assembly having a housing positioned externally adjacent said vessel at said wall opening therein, said housing being interiorly divided into first and second chambers by a flexible diaphragm member, a tubular connection portion extending outwardly from said housing and threaded into said wall opening, said tubular connection portion having an interior communicated with the interior of said first chamber, a movable actuating member extending through said second chamber and outwardly through said housing, said movable actuating member being drivable further outwardly from said housing by said diaphragm member in response to pressurization of said first chamber, and an imperforate tubular sacrificial member longitudinally extending into said vessel, said sacrificial having an enclosed interior communicating with the interior of said tubular connection portion, an open outer end sealingly secured to said tubular connection portion, and a closed inner end, the imperforate outer wall of said sacrificial member being configured and constructed to corrode through to the interior of said sacrificial member in response to exposure of said sacrificial member to a predetermined combination of fluid exposure time and fluid chemical corrosivity within the vessel correlated to a predetermined amount of chemical corrosion and/or mechanical erosion by the fluid of the interior of said vessel, a chemical corrosion-created hole in the outer wall of said imperforate sacrificial member causing pressurized fluid within said vessel to enter and pressurize the interior of said sacrificial member,
an electrical switch having a body portion from which a depressible mechanical actuating portion outwardly projects, said mechanical actuating portion being engaged and depressible by said movable actuating member, and
an electrical circuit coupled to said switch and operable thereby to responsively generate a corrosion detection signal.
